(19) United States
(12) Patent Application Publication
(10) Pub. No.: US 2006/0183463 A1
(43) Pub. Date: Aug. 17, 2006

(54) Method for authenticated connection setup

(75) Inventors: Rainer Falk, Poing (DE); Dirk Kroselberg, Munchen (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 11/348,528

(22) Filed: Feb. 7, 2006

(30) Foreign Application Priority Data
Feb. 8, 2005 (EP) 05002603.8

(51) Int. Cl. H04M 1/66

(52) U.S. Cl. 455/411; 713/167

(57) ABSTRACT

The invention relates to a method for the authenticated establishment of a connection between a mobile subscriber and a WLAN radio communication system. The mobile subscriber signs on as a guest to an access point of the WLAN network via an insecure connection or via a secure connection that is only authenticated on the network side and an individual IP address is assigned to the mobile subscriber. Using the individual IP address, the mobile subscriber accesses a portal page and authenticates himself/herself in a person-related manner to the portal page. Person-related authentication data is assigned to the mobile subscriber using a Security Assertion Markup Language. In a new connection setup as part of a secure Link Layer connection, the person-related authentication data is transmitted to an AAA server for final authentication of the mobile subscriber.

### CLAIM FOR PRIORITY

This application claims the benefit of priority to European Application No. 05002603.8, filed in the German language on Feb. 8, 2005, the contents of which are hereby incorporated by reference.

### TECHNICAL FIELD OF THE INVENTION

The invention relates to a method for the authenticated establishment of a connection between a mobile subscriber and a WLAN radio communication system.

### BACKGROUND OF THE INVENTION

WLAN radio communication systems are known in which mobile subscribers exchange data with a WLAN access point over insecure connections.

Also known are radio communication systems referred to as “Public WLANs” (PWLANS) which are operated for example by hotels, airports and similar service providers. Subject to payment of usage charges a mobile subscriber can make use of special services which are made available by the respective provider. Because of the usage charges to be paid, methods enabling secure access to the WLAN or PWLAN networks as well as secure data transmission are becoming increasingly important.

In the following, two methods supporting authorized access by a mobile subscriber to a PWLAN network or, as the case may be, WLAN network will be described.

In a first method, known as the “Universal Access Method” (UAM), a mobile subscriber accesses what is referred to as an “access point” of the network without the connection being protected.

After setting up a local IP connection the mobile subscriber sends an HTTP request to the access point, said request being forwarded to an HTML portal page. The HTML portal page is made available for example by an HTTP server or by a “Service Selection Gateway” (SSG) or by some other appropriate device.

The HTML portal page displays specific information relating to the network—for example, internet services offered are displayed together with the respective usage charges. In addition, an access code can be requested by the HTML portal page, said access code consisting for example of a user name and/or password. It is usual in a hotel, for example, to purchase a “prepaid” card and thereby acquire an access code that is printed on the card. In this way it is not possible to obtain information pertaining to the person of the mobile subscriber on the network side.

After being input via the HTML portal page, the access code is checked by a device associated with the HTML portal page. If the mobile subscriber is recognized as authorized, filters are formed which permit the mobile subscriber to access the internet services offered. After a usage time predefined at the time of the purchase of the prepaid card has expired, these filters are removed, thus preventing further access.

In a second method, use is made of a protocol referred to as the “Extensible Authentication Protocol” (EAP). With this, a home network in which the mobile subscriber is known or registered authenticates the mobile subscriber to an inquiring PWLAN network or, as the case may be, WLAN network, whereupon said mobile subscriber is permitted to access the PWLAN network or WLAN network. This method offers for example the advantage of cross-network billing, in which case it is possible to dispense with additional charging means such as the above-mentioned “prepaid” card or similar.

Specifically, the mobile subscriber registers (“signs on”) as a guest at an access point of the WLAN/PWLAN network. Toward that end, for the purpose of authentication he/she sends a “null” as user name via a secure connection using a protocol known as the “Protected Extensible Authentication Protocol—Transport Layer Security” (PEAP-TLS). Further inputs for authentication are not necessary. The mobile subscriber thus performs an anonymous, non-person-related authentication.

The authentication of the mobile subscriber as a guest is recognized on the network side using, for example, what is known as an “Internet Authentication Service” (IAS).

A “Uniform Resource Locator” (URL) is assigned to the mobile subscriber as an address which designates a “provisioning” server. The mobile subscriber is allowed to perform data accesses or is allocated resources by the provisioning server.

The URL address is transmitted to the mobile subscriber in protected form using the above-mentioned “PEAP-TLS” protocol. In addition, an individual IP address is assigned and communicated to the mobile subscriber.

The IP address is assigned for example using a protocol called the “Dynamic Host Configuration Protocol” (DHCP), which enables a dynamic assignment of a terminal to IP addresses of a network. A mobile subscriber terminal under consideration can therefore have different IP addresses in each case for different network connections.

It is known to transmit a “Hypertext Transfer Protocol” (HTTP) via a secure connection, with a “Transport Layer Security” (TLS) or a “Secure Socket Layer” (SSL) being used to provide the security. A secure connection of said kind for transmitting the HTTP protocol is referred to as an HTTPS connection.

The mobile subscriber is connected via a secure HTTPS connection to a network-side HTTP server which requests specific data associated with the mobile subscriber, such as for example name, address, credit card information or similar.

A “Wireless Provisioning Service” (WPS) for example can be used for this request.

On the HTTP server side, a user profile referred to as a “user account” is set up taking into account the requested mobile subscriber data. The user profile is transmitted to the mobile subscriber, the user profile containing authentication data referred to as “credentials”.

Following reception of the authentication data, the existing connection to the access point is terminated. When a subsequent new connection to the access point is set up, the mobile subscriber transmits the authentication data assigned to him/her.

On the network side, the mobile subscriber, using his/her “credentials”, is authenticated using the “Internet Authentication Service” (IAS). Subsequently, network-side filters are formed which permit the mobile subscriber to access internet services offered in each case.

### SUMMARY OF THE INVENTION

The present invention discloses a method for authentication of a mobile subscriber in a WLAN or PWLAN network which can be implemented with lower overhead and increased security.

In one embodiment according to the invention, security measures of a service level are individually assigned to the mobile subscriber, and referred to as the “application layer,” and a connection level, not individually assigned to the mobile subscriber, and referred to as the “link layer,” are combined.

The “link layer” security is implemented through use of the “Extensible Authentication Protocol” (EAP) described in the introduction.

The “application layer” security is implemented through use of a language known as the “Security Assertion Markup Language” (SAML) which preferably uses a frame protocol with an “Extensible Markup Language” (XML). The term “SAML” is used to define a method for exchanging information serving for authentication, authorization and so-called “nonrepudiation”.

With the aid of the “nonrepudiation” information it is ensured that a transmitted message can be uniquely associated with a sending party or that a recipient of a message can be unequivocally verified.

### BRIEF DESCRIPTION OF THE DRAWINGS

The invention is described in more detail below with reference to the exemplary embodiments and the figures, in which:

FIG. 1 shows an emec

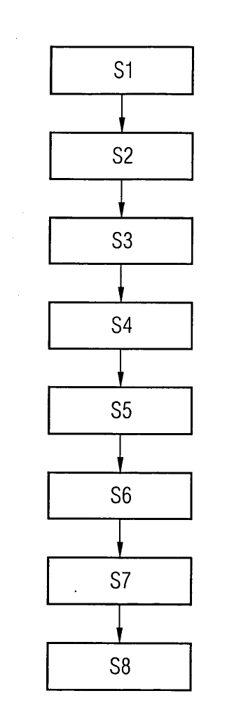

### DETAILED DESCRIPTION OF THE INVENTION

In a first step S1, the mobile subscriber signs on to a WLAN network or, as the case may be, PWLAN network as a guest via an access point by transmitting for example only a “null” as the user name over an insecure connection.

In a second step S2, the sign-on is recognized by a network-side “Authorization,Authentication,Accounting” (AAA) server. An IP address is individually assigned to the mobile subscriber by means of the “Dynamic Host Configuration Protocol” (DHCP) and transmitted to the mobile subscriber.

On the AAA server side, as part of the checking process referred to as “Authorization” the services which the mobile subscriber is allowed to access from all those offered are specified. Depending on a “user authorization level” assigned to the mobile subscriber, the mobile subscriber is provided with a predetermined set of information. As part of a registration process referred to as “Authentication”, a combination of user name and password is typically used for each mobile subscriber. As part of a billing method referred to as “Accounting”, access times and accesses to internet pages are registered. With the aid of the recorded “accounting” data it is made possible to carry out trend analyses, capacity planning, billing, cost allocation and system tests.

In a third step S3, the mobile subscriber establishes a secure connection that is only authenticated on the server side to a server portal page and authenticates himself/herself to the portal page via said secure connection.

For authentication purposes, the mobile subscriber could, for example, use a combination of user name and password related to his/her person. Alternatively it would also be possible to perform an authentication based on a certificate and related to the person of the mobile subscriber. In this case the communication with the portal page is conducted over a secure connection using, for example, the HTTPS protocol.

In a fourth step S4, the mobile subscriber is assigned what are referred to as “credentials” as authentication data on the portal page server side.

According to the invention, what is referred to as a “SAML assertion” or SAML declaration or a “SAML artifact” or SAML test certificate is used for this purpose. Both the “SAML artifact” and the “SAML assertion” can be assigned either directly or indirectly to the person of the mobile subscriber.

With the “Security Assertion Markup Language” (SAML), what is referred to as an “asserting party” is defined for a confirmation that is to be carried out and what is referred to as a “relying party” is defined for a reliability check that is to be carried out. The server portal page is used as the “asserting party”, while the AAA server is used as the “relying party”.

In a fifth step S5, the “credentials” are transmitted to the mobile subscriber over a secure connection using the HTTPS protocol, and in a sixth step S6 the current connection is terminated.

In a seventh step S7, a new Link Layer connection is set up to the AAA server on the mobile subscriber side via the access point.

In an eight step S8, the mobile subscriber authenticates himself/herself to the AAA server by transmitting the “credentials”, that is to say the “SAML artifact” or the “SAML assertion”.

The authentication is carried out using the EAP protocol—i.e. a home network in which the mobile subscriber is known or registered authenticates the mobile subscriber to the inquiring AAA server of the WLAN/PWLAN network. Once the authentication has been completed, the mobile subscriber is permitted to access the WLAN/PWLAN network, with corresponding filters being formed to allow access to the internet services offered.

What is claimed is:

1. A method for authenticated connection setup between a mobile subscriber and a WLAN radio communication system, comprising:
signing-on as a guest to an access point of the WLAN network via connection that is authenticated on the network side and assigning an individual IP address to the mobile subscriber;
using the individual IP address to access a portal page and authenticating himself/herself to the portal page in a person-related manner;
using a Security Assertion Markup Language to assign person-related authentication data to the mobile subscriber; and
transmitting, in a new connection setup as part of a secure Link Layer connection, the person-related authentication data to an AAA server for final authentication of the mobile subscriber.

2. The method as claimed in claim 1, wherein the individual IP address is assigned by an AAA server using the Dynamic Host Configuration Protocol.

3. The method as claimed in claim 1, wherein the mobile subscriber accesses the portal page via a server only connection.

4. The method as claimed in claim 1, wherein the authentication of the mobile subscriber to the portal page is carried out using a secure transmission method.

5. The method as claimed in claim 1,
wherein the person-related authentication to the portal page is carried out by specification of a user name related to the person of the mobile subscriber and/or a password, or
the person-related authentication to the portal page is carried out based on a certificate.

6. The method as claimed in claim 5, wherein the person-related authentication to the portal page is carried out over a secure connection using the HTTPS protocol.

7. The method as claimed in claim 1, wherein a person-related SAML assertion or a person-related SAML artifact is used as authentication data.

8. The method as claimed in claim 7, wherein, in the authentication using the Security Assertion Markup Language, the portal page is used as the asserting party and the AAA server as the relying party.

9. The method as claimed in claim 1, wherein the person-related authentication data is transmitted to the mobile subscriber over a secure connection using the HTTPS protocol.

10. The method as claimed in claim 2, wherein the Link Layer connection is set up to the AAA server.

11. The method as claimed in claim 1, wherein the authentication via the Link Layer connection is carried out using the EAP protocol, with a home network in which the mobile subscriber is known authenticates the mobile subscriber to the inquiring AAA server of the WLAN network.
